(19) United States
(12) Patent Application Publication
(10) Pub. No.: US 2026/0044873 A1
(43) Pub. Date: Feb. 12, 2026

(54) SYSTEM AND INFORMATION PROCESSING APPARATUS

(71) Applicant: TOYOTA JIDOSHA KABUSHIKI KAISHA, Toyota-shi (JP)

(72) Inventor: Toyokazu NAKASHIMA, Nagoya-shi (JP)

(73) Assignee: TOYOTA JIDOSHA KABUSHIKI KAISHA, Toyota-shi (JP)

(21) Appl. No.: 19/294,059

(22) Filed: Aug. 7, 2025

(30) Foreign Application Priority Data
Aug. 9, 2024 (JP) 2024-134562

(51) Int. Cl. G06Q 30/0226; B60R 25/24; G06Q 40/08

(52) U.S. Cl. CPC G06Q 30/0231; B60R 25/24; G06Q 40/086; B60R 2325/205

(57) ABSTRACT

Vehicle theft prevention measures are promoted by providing a controller configured to receive, from a vehicle, information corresponding to the vehicle theft prevention measures performed by a user; and output information for providing an incentive to the user according to the information received from the vehicle.

### CROSS REFERENCE TO THE RELATED APPLICATION

This application claims the benefit of Japanese Patent Application No. 2024-134562, filed on Aug. 9, 2024, which is hereby incorporated by reference herein in its entirety.

### BACKGROUND

### Technical Field

The present disclosure relates to a system and an information processing apparatus.

### Description of the Related Art

As a measure against theft, a technology is known to improve the security of an electronic key system by providing a motion-sensor on the key, and adding the motion of the key detected by the motion sensor to the conditions for enabling unlocking of the vehicle door, starting of the engine, etc. (for example, Patent Document 1).

### CITATION LIST

### Patent Literature

Patent Literature 1: JP 2021-079867

### SUMMARY

The purpose of the present disclosure is to promote anti-theft measures for vehicles.

One aspect of the present disclosure is a system comprising:
an electronic key;
a vehicle having a function of a smart key corresponding to the electronic key;
a server having a controller and a storage;
a terminal of a user; wherein
the electronic key transmits, to the vehicle in response to an input that causes the transmission of the radio wave to be stopped, first information on the cessation of the transmission of the radio wave;
in response to receiving the first information from the electronic key, the vehicle transmits to the server second information regarding the electronic key stopping the transmission of the radio wave; and
the controller of the server is configured to:
   calculate, in response to receiving the second information, a number of times the transmission of the radio wave is stopped in the electronic key, and storing the number of times in the storage;
   generate third information for granting the incentive to the user so that the incentive increases as the number of times is increased; and
   generate an instruction for causing the display of the generated image according to the third information on the display of the terminal of the user, and transmit the instruction to the terminal of the user; and
the terminal of the user, in response to receiving the command from the server, causes the image to be displayed on the display.

One of another aspect of the present disclosure is an information processing apparatus comprising a controller configured to execute:
receiving, from a vehicle, information corresponding to the vehicle theft prevention measures performed by a user; and
outputting information for granting incentives to the user in response to the information received from the vehicle.

The present disclosure can also be understood as an information processing method in which a computer executes the processing of the above-mentioned information processing apparatus. In addition, the present disclosure can be viewed as an information processing program for causing the computer to execute the information processing method, or as a non-transitory storage medium storing the information processing program.

According to the present disclosure, anti-theft measures of the vehicle can be promoted.

### BRIEF DESCRIPTION OF THE DRAWINGS

FIG. 1 is a block diagram schematically illustrating an example configuration of each of a vehicle, a user terminal, a server, and an electronic key constituting a system according to an embodiment.

FIG. 2 is a diagram illustrating a table configuration of the vehicle information DB.

FIG. 3 is a sequence diagram illustrating an overall processing of the system when granting incentives according to anti-theft measures according to an embodiment.

FIG. 4 is a flowchart illustrating processing of updating the vehicle information DB in the server according to an embodiment.

FIG. 5 is a flowchart illustrating the processing of granting an incentive to a user in the server according to an embodiment.

### DESCRIPTION OF THE EMBODIMENTS

It is conceivable to install a motion-sensor on the electronic key of the smart key system as a measure against theft against the vehicle. However, it is necessary to provide a motion-sensor in the electronic key, and it is difficult to apply it to existing smart key systems. On the other hand, the information processing apparatus according to the present disclosure uses existing functions to promote anti-theft measures. Therefore, the information processing apparatus according to the present disclosure grants an incentive to a user who has implemented a vehicle theft countermeasure.

Specifically, the controller included in the information processing apparatus according to the present disclosure receives, from a vehicle, information corresponding to the vehicle theft prevention measures performed by a user. The vehicle theft prevention measures include at least one of: stopping transmission of radio waves from an electronic key corresponding to a smart key provided in the vehicle; installing lighting in a parking lot of the vehicle; attaching a lock to a steering wheel of the vehicle; and parking the vehicle in a parking lot having a shutter. The information corresponding to the vehicle theft prevention measures may include a detection value of a sensor capable of detecting that the user has taken anti-theft measures, or that the user has not taken anti-theft measures. Here, by stopping the transmission of radio waves from the electronic key, it is possible to prevent theft by a so-called relay attack, which uses these radio waves to unlock the vehicle and start the engine. Further, the theft of the vehicle at night can be suppressed because the user can suppress the approach of the thief to the vehicle at night by installing the lighting in the parking lot. In addition, by installing a lock on the steering wheel of the vehicle, it is difficult for the thief to drive the vehicle, so that theft of the vehicle can be suppressed. In addition, by parking in a parking lot having a shutter, theft of the vehicle can be suppressed because the entry of thieves into the parking lot or the movement of the vehicle from the parking lot is suppressed. The fact that the user has implemented such anti-theft measures can be detected by a sensor or the like in the vehicle. Therefore, it is possible for the controller to obtain information corresponding to the theft countermeasure from the vehicle when the user implements the theft countermeasure. Then, by granting incentives to the user who has implemented the anti-theft measures, the user can be given an opportunity to implement the anti-theft measures. Providing incentives to users includes discounting vehicle insurance premiums. In this way, the theft of the vehicle can be reduced.

In addition, the information corresponding to the vehicle theft prevention measures may include information regarding locking of the vehicle when the user is not in the vehicle; and the controller may output the information for granting the incentive so that, in the predetermined period, the less number of times the vehicle is not locked when the user is not on board, the greater the incentive to grant to the user. For example, if the user forgets to lock and leaves the vehicle, there is a high possibility of theft. Therefore, locking the lock by the user is also a countermeasure against theft. The smaller the number of times the vehicle is not locked when the user is not in the vehicle, the greater the incentive, the more likely the user will lock the vehicle, thereby discouraging vehicle theft. As another example, the controller may output information for granting the incentive to the user such that the smaller the ratio of the number of times the vehicle was not locked when the user was not in the vehicle to the number of times the vehicle was locked when the user was not in the vehicle during a specified period, the larger the incentive granted to the user.

In addition, the information corresponding to the vehicle theft prevention measures may include information on disembarkation of the user when an engine of the vehicle is running, and the controller may output information for granting the incentive so that, in a predetermined period, the fewer times the user disembarks when the engine of the vehicle is running, the greater the incentive to grant to the user. For example, if the user moves away from the vehicle while the engine is running, the probability of theft increases. Therefore, if the user gets off the vehicle with the engine stopped, this serves as an anti-theft measure. The smaller the number of times the user dismounts when the vehicle's engine is running, the greater the incentive, so that the user stops the engine and gets off, so that vehicle theft can be suppressed. As another example, the controller may output the information for giving the incentive such that the incentive to be given to the user increases as a ratio of the number of times the user gets off the vehicle when an engine of the vehicle is operating to the number of times the user gets off the vehicle when the engine of the vehicle is stopped decreases in a predetermined period.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

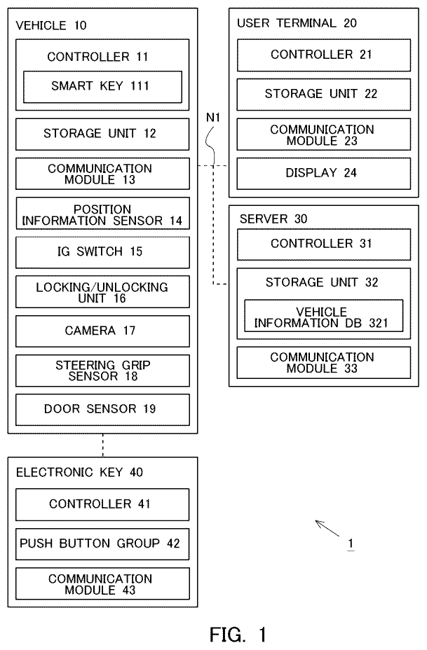

FIG. 1 is a block diagram schematically illustrating an example of each configuration of the vehicle 10, a user terminal 20, the server 30, and an electronic key 40 constituting a system 1 according to an embodiment. The system 1 is a system that grants incentives to a user (who may be a driver) who has implemented anti-theft measures. In the example illustrated in FIG. 1, the system 1 is configured to include a vehicle 10, the user terminal 20, a server 30, and the electronic key 40. The user terminal 20 is a mobile terminal owned by the user of the vehicle 10. The vehicle 10 is a connected vehicle with a communication function. In addition, the vehicle 10 is a vehicle associated with the user terminal 20. The vehicle 10 and the user terminal 20 can each be multiple. The electronic key 40 is a terminal that enables locking and unlocking of the door of the vehicle 10 by remote control of the user. The electronic key 40 is associated with the vehicle 10. The server 30 transmits information on the incentive to the user terminal 20. The vehicle 10, the user terminal 20, and the server 30 are connected to each other by a network N1. Note that the network N1 is, for example, a worldwide public communication network such as the Internet, and a wide area network (WAN) or another communication network may be adopted. Further, the network N1 may include a telephone communication network such as a mobile phone, and a wireless communication network such as Wi-Fi (registered trademark).

The server 30 may be configured as a computer having a processor (CPU, GPU, etc.), a main storage device (RAM, ROM, etc.), and an auxiliary storage device (EPROM, hard disk drive, removable medium, etc.). An operating system (OS), various programs, various tables, etc. are stored in the auxiliary storage device, and by executing the program stored therein, each function (software module) suitable for a predetermined purpose as described later can be realized. However, some or all of the modules may be implemented as hardware modules, for example, using hardware circuits such as ASICs or FPGAs.

The server 30 includes a controller 31, a storage unit 32, and a communication module 33. The controller 31 is an operation unit that executes a predetermined program to realize various functions of the server 30. The controller 31 may be realized by, for example, a hardware processor such as a CPU. In addition, the controller 31 may be configured to include RAM, ROM, cache memory, etc. Details of the controller 31 will be described later.

The storage unit 32 is a means for storing information, and is configured by a storage medium such as RAM, a magnetic disk, a flash memory, etc. The storage unit 32 stores the program executed by the controller 31, the data used by the program, etc. Further, a database (vehicle information DB321) is constructed in the storage unit 32.

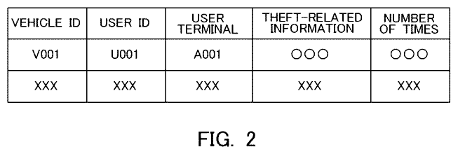

FIG. 2 is a diagram illustrating a table configuration of the vehicle information DB 321. The vehicle information DB 321 includes fields for vehicle ID, user ID, user terminal, theft-related information, and number of times. In the vehicle ID field, information (vehicle ID) capable of identifying the vehicle 10 is stored. In the user ID field, information (user ID) that can identify a user of the vehicle 10 is stored. The user terminal field contains information that can be used to contact the user terminal 20 associated with the vehicle 10 (for example, email address, social media account, address, or phone number). The theft-related information field stores information on events related to anti-theft measures (hereinafter also referred to as theft-related information). The theft-related information includes information related to an event that becomes a theft countermeasure when performed by the user, or information related to an event that increases the possibility of being stolen when performed by the user. The information stored in the theft-related information field includes radio wave stop detection information, lighting information, steering lock information, shutter information, unlocked information, and IG-on disembarkation information, which will be described later. The number of times field stores information on the number of occurrences of events corresponding to the theft-related information field. It should be noted that instead of the number of times field, there may be a time field in which information on the time of occurrence of the event corresponding to the theft-related information field is stored. An incentive field stores information on incentives to be granted to the user. The information on the vehicle ID, the user ID, and the user terminal may be registered to the server 30 by the user.

The communication module 33 is a communication interface for connecting the server 30 to a network N1. The communication module 33 may be configured to include, for example, a network interface board, a wireless communication interface for wireless communication, etc. The server 30 can perform data communication with the vehicle 10 and the user terminal 20 via the communication module 33.

The vehicle 10 includes a controller 11, a storage unit 12, a communication module 13, a position information sensor 14, an IG switch 15, a locking/unlocking unit 16, a camera 17, a steering grip sensor 18, and a door sensor 19. These are connected to each other by the CAN bus, which is the bus of the in-vehicle network. Note that these components can be components such as a DCM (Data Communication Module), a head unit, a navigation system, an air conditioner system, and a driving system.

The controller 11 of the vehicle 10 may be realized by, for example, a hardware processor such as a CPU. In addition, the controller 11 may be configured to include RAM, ROM (Read Only Memory), cache memory, etc. The storage unit 12 is a means for storing information, and is composed of a storage medium such as RAM, a magnetic disk, a flash memory, etc. The storage unit 12 stores the program executed by the controller 11, the data used by the program, etc.

The communication module 13 is a communication means for connecting the vehicle 10 to a network N1. In the present embodiment, the vehicle 10 can communicate with another device (e.g., the server 30) via a network N1 using a mobile body communication service such as 3G, LTE, 5G, and 6G. The position information sensor 14 acquires position information (e.g., latitude, longitude) of the vehicle 10 at a predetermined period. The position information sensor 14 is, for example, a GPS (Global Positioning System) receiver, a wireless communication unit, etc.

The IG switch 15 is a switch for starting the engine of the vehicle 10 or stopping the engine of the vehicle 10 when pressed by the user. In the following, the state in which the IG switch 15 is on is referred to as IG-on, and the state in which the IG switch 15 is off is referred to as IG-off. The engine is running when the IG is on, and the engine is stopped when the IG is off. In the case where the vehicle 10 is an electric vehicle or a hybrid vehicle, a power switch may be provided. The power switch is a switch for activating the vehicle 10 or stopping the function of the vehicle 10 by pressing it by the user. The locking/unlocking unit 16 performs unlocking of the door of the vehicle 10. The locking/unlocking unit 16 includes an actuator. The camera 17 is a device for performing imaging using an imaging element such as, for example, a Charge Coupled Device (CCD) image-sensor, or a Complementary Metal Oxide Semiconductor (CMOS) image-sensor. The image obtained by the imaging may be either a still image or a moving image. The steering grip sensor 18 is a sensor that detects the position where the driver is holding the steering wheel. The door sensor 19 is a sensor that detects the opening and closing of the door.

Every predetermined time, the controller 11 of the vehicle 10 transmits to the server 30 the detection value of the position information sensor 14, the image taken by the camera 17, the detection value of the steering grip sensor 18, the detection value of the door sensor 19, the information on the state of the unlocking lock of the door by the locking/unlocking unit 16, and the information on the state of the IG switch 15. Note that the image to be transmitted to the server 30 may be an image taken, for example, at a predetermined time (e.g., for tens of seconds) before and after the vehicle 10 stops. The state of the IG switch 15 is information indicating whether it is an IG-on state or an IG-off state.

The controller 11 also has the function of a smart key 111 of a smart key system that locks and unlocks the doors by controlling the locking/unlocking unit 16 based on a signal from the electronic key 40. The controller 11 uses the function of the smart key 111 to wirelessly communicate with the electronic key 40 described later. Here, the smart key 111 transmits a polling signal every predetermined time to detect the electronic key 40. The electronic key 40 that receives the polling signal transmits the reply signal to the vehicle 10. Based on the reply signal, the smart key 111 performs authentication of the electronic key 40. Upon successful authentication of the electronic key 40, the smart key 111 accepts a request for unlocking the door by the electronic key 40. In such a configuration smart key system, there is a risk of theft of the vehicle 10 due to a so-called relay attack. On the other hand, it is known to stop the transmission of radio waves from the electronic key 40. This function may be, for example, a function for saving electricity of the electronic key 40. Before transmission of radio waves is stopped in the electronic key 40, the controller 11 of the electronic key 40 transmits information on stopping transmission of radio waves (hereinafter also referred to as radio wave stop information) to the vehicle 10. This enables the controller 11 to detect that transmission of radio waves from the electronic key 40 has been stopped. In response to receiving the radio wave stop information, the controller 11 transmits to the server 30 information on detection of a stop of transmission of radio waves from the electronic key 40 (hereinafter also referred to as radio wave stop detection information).

In addition, if the user moves away from the vehicle 10 without locking the door during parking, the controller 11 notifies the server 30 to that effect. The information transmitted from the vehicle 10 to the server 30 at this time is hereinafter also referred to as “unlocked information”. For example, if the locking of the door is not implemented within a predetermined time after the door is opened and closed in the IG-off state, the controller 11 may transmit the unlocked information to the server 30. As another example, for example, if the electronic key 40 is more than a predetermined distance away from the vehicle 10 in the state of IG-off, the controller 11 may transmit the unlocked information to the server 30. The predetermined distance may be, for example, a communicable distance between the vehicle 10 and the electronic key 40. The controller 11 determines that the vehicle 10 is parked when the IG is off. As another example, the controller 31 of the server 30 may determine whether the user leaves the vehicle 10 without locking the door while the vehicle is parked. For example, the controller 31 of the server 30 may make a determination based on information on the state of the IG switch 15 transmitted from the vehicle 10 to the server 30, a detection value of the door sensor 19, and information on the state of the unlocking lock by the locking/unlocking unit 16.

In addition, if the user gets out of the vehicle 10 while the engine of the vehicle 10 is running, the controller 11 notifies the server 30 to that effect. The information transmitted from the vehicle 10 to the server 30 at this time is also referred to as “IG-on disembarkation information” in the following. For example, if the door is opened and closed in the IG-on state, the controller 11 may send a notification to the server 30. Further, the condition may be that the sensor detects that the seat belt on the driver's side is removed before the door is opened and closed. As another example, for example, if the electronic key 40 is separated from the vehicle 10 by a predetermined distance or more in the IG-on state, the controller 11 may transmit IG-on disembarkation information to the server 30. The predetermined distance may be, for example, a communicable distance between the vehicle 10 and the electronic key 40. As another example, the controller 31 of the server 30 may determine whether the user has dismounted from the vehicle 10 while the engine of the vehicle 10 is running. For example, the controller 31 of the server 30 may determine based on the information on the state of the IG switch 15 transmitted from the vehicle 10 to the server 30 and the detection value of the door sensor 19.

The electronic key 40 is a device for remotely operating the locking/unlocking unit 16 of the vehicle 10. The electronic key 40 includes a controller 41, a group of push button group 42, and a communication module 43. The controller 41 of the electronic key 40 may be realized by, for example, a hardware processor such as a CPU. In addition, the controller 41 may be configured to include RAM, ROM (Read Only Memory), cache memory, etc. The push button group 42 includes push-buttons corresponding to locking, unlocking, etc. of the vehicle 10. The communication module 43 is an apparatus for performing wireless communication with the vehicle 10. The communication module 43 transmits a signal to the vehicle 10 for locking and unlocking the door of the vehicle 10. The controller 41 transmits a signal corresponding to any of the push button group 42 to the vehicle 10 via the communication module 43 in response to the user pressing any of the push button group 42. Further, the controller 41 of the electronic key 40 that receives the polling signal from the vehicle 10 transmits the reply signal to the vehicle 10. In addition, the controller 41 of the electronic key 40 causes the transmission of radio waves from the electronic key 40 to stop when the push button group 42 is pressed in a predetermined order. Then, even if the polling signal is received from the vehicle 10, the controller 41 does not transmit the reply signal. This enables anti-theft measures for the vehicle 10 and power saving for the electronic key 40. The controller 41 of the electronic key 40 transmits information on stopping transmission of radio waves (radio wave stop information) to the vehicle 10 just before stopping transmission of radio waves from the electronic key 40.

The user terminal 20 is a terminal used by the user of the vehicle 10, for example, a smartphone, a tablet terminal, a wearable terminal, or a personal computer (PC). The user terminal 20 has installed application software capable of receiving notifications from, for example, the server 30. The user terminal 20 includes a controller 21, a storage unit 22, a communication module 23, and a display 24. The controller 21 of the user terminal 20 may be realized by, for example, a hardware processor such as a CPU. In addition, the controller 21 may be configured to include RAM, ROM (Read Only Memory), cache memory, etc. The storage unit 22 is a means for storing information, and is composed of a storage medium such as RAM, a magnetic disk, a flash memory, etc. The storage unit 22 stores the program executed by the controller 21 and the data used by the program. The communication module of the user terminal 20 is configured in the same manner as the communication module 13 of the vehicle 10. The display 24 is a means for presenting information to the user, for example, a liquid crystal display (LCD) or an electroluminescence (EL) panel. The display 24 may be configured as a touch screen with a touch panel.

When the controller 21 of the user terminal 20 receives information from the server 30, the controller 21 causes the display 24 to display an image corresponding to the information. For example, if information on granting an incentive is received from the server 30, the controller 21 causes the contents of the incentive to be displayed on the display 24. In addition, if the controller 21 receives, for example, information from the server 30 for notifying that the door is forgotten to be locked, the controller 21 causes the display 24 to display a text indicating that the door is forgotten to be locked.

Next, the controller 31 of the server 30 determines whether an event related to anti-theft measures has occurred based on various information received from the vehicle 10. This various information includes the detection value of the position information sensor 14, the image taken by the camera 17, the detection value of the steering grip sensor 18, the detection value of the door sensor 19, the information on the state of the unlocking lock of the door by the locking/unlocking unit 16, the information on the state of the IG switch 15, the radio wave stop detection information, the unlocked information, and the IG-on disembarkation information. Thus, various kinds of information transmitted from the vehicle 10 to the server 30 are also referred to as detection information in the following. The event referred to here is an event corresponding to information stored in the theft-related information field of the vehicle information DB 321. In addition, the controller 31 identifies the corresponding theft-related information field from the identified theft-related information, adds 1 to the value of the number of times field of the same record, and updates the number of times field. The controller 31 assigns an incentive to the user according to the number of times stored in the number of times field. The incentive may be a discount of the insurance premium, for example, when the user contracts insurance for the vehicle 10. As another example, the incentive may be a coupon that can be used at a predetermined store or may be electronic money. Further, as another example, the incentive may be a discount on the maintenance cost of the vehicle 10, or a discount on the purchase cost when purchasing the vehicle 10.

Events related to anti-theft measures include those listed in (1) to (6) below. These may be stored in theft-related information fields of different records in the vehicle information DB 321.
(1) Stopping transmission of radio waves from the electronic key 40 (corresponding to radio wave stop detection information)
(2) Installation of lighting in parking lots (corresponding to lighting information)
(3) Attaching the lock to the steering wheel of the vehicle 10 (corresponds to the steering lock information)
(4) Parking in a parking lot with a shutter (corresponds to shutter information)
(5) Disembarkation without locking the door (corresponds to unlocked information)
(6) Disembarkation without engine stop (corresponds to IG-on disembarkation information)

At least one of the items (1) to (6) may be stored in the theft-related information field of the vehicle information DB 321. In other words, it is sufficient for the controller 31 of the server 30 to collect information on at least one of (1) to (6). (1) to (4) are actions that, if performed by a user, will reduce the likelihood of theft, while (5) and (6) are actions that, if performed by a user, will increase the likelihood of theft.

### Regarding (1)

By causing the user to stop transmitting radio waves from the electronic key 40, theft caused by a relay attack may be suppressed. Therefore, the controller 31 of the server 30 grants an incentive to the user based on the number of times the transmission of the radio wave from the electronic key 40 is cancelled, or the time the transmission of the radio wave from the electronic key 40 is cancelled. Therefore, when the controller 31 of the server 30 receives the radio wave stop detection information, the controller 31 identifies the record in which the radio wave stop detection information is stored in the theft-related information field of the vehicle information DB 321. Since the radio wave stop detection information includes information on the vehicle ID and the user ID, the controller 31 identifies a record in which the radio wave stop detection information is stored from among the records in which the vehicle ID and the user ID match. Further, the controller 31 accumulates the number of times the radio wave stop detection information is received by adding 1 to the number of times stored in the number of times field of the specified record. The controller 31 stores the number of times after accumulation in the number of times field. As another example, the server 30 may accumulate the time during which transmission of the radio wave from the electronic key 40 is stopped. In this case, if transmission of radio waves from the electronic key 40 is resumed, the controller 11 of the vehicle 10 that receives the radio waves from the electronic key 40 may notify the server 30 that transmission of radio waves from the electronic key 40 is resumed.

The controller 31 of the server 30 grants an incentive to the user based on the number of times accumulated or the time accumulated. The incentive may be, for example, a discount on the insurance of the vehicle 10. For example, the controller 31 of the server 30 may increase the discount of the insurance as the number of times accumulated increases, or the amount of time accumulated increases. The relationship between the accumulated number of times or the accumulated time and the discount rate of the insurance may be stored in the storage unit 32. In addition, the controller 31 may cause the storage unit 32 to store the calculated discount rate of the insurance. As another example, the controller 31 may grant an incentive or change the size of the incentive according to the time period (for example, whether or not it is night) when the transmission of radio waves from the electronic key 40 is stopped. Since theft is more likely at night than during the day, the incentive may be greater if the transmission of radio waves from the electronic key 40 is stopped during the night time rather than during the day. In addition, the number of times may be accumulated and an incentive may be granted only if the transmission of the radio wave from the electronic key 40 is stopped at the time of the night.

### Regarding (2)

By installing lighting in the parking lot of the vehicle 10, theft at night can be suppressed. The controller 31 of the server 30 grants an incentive to the user when a lighting is installed in the parking lot of the vehicle 10. Therefore, the controller 31 of the server 30 determines whether or not lighting is installed in the parking lot of the vehicle 10. The parking lot is a parking lot that is commonly used by the user, and may be, for example, a parking lot at the user's home. The lighting may be a sensor light. The sensor light is equipped with a motion-sensor (e.g., an infrared sensor), and is a light that automatically lights up when a person is detected by the motion sensor. The fact that lighting has been installed can be determined, for example, by analyzing an image captured by the camera 17. Known technology may be used to make this determination. Further, a machine learning model may be used for this determination. The controller 31 may analyze the image using a deep learning method such as, for example, YOLO, CNN, SDD, etc., and determine the presence of illumination. As another example, it is also possible to determine that lighting is installed using an illuminance-sensor provided in the vehicle 10. For example, if an illuminance of the predetermined value or more is detected at night in the parking lot of the home, the controller 31 may determine that the lighting is installed in the parking lot of the vehicle 10. In addition, the controller 31 may determine whether the place where the vehicle 10 is stopped is a parking lot at home based on the detection value of the position information sensor 14. The location of the home is registered by the user to the server 30 in advance. As another example, the controller 31 may determine, for example, the position where the time of IG-off is the longest during the predetermined period (for example, one week or one month) as the parking lot at home.

When the controller 31 of the server 30 deems that lighting is installed in the parking lot of the vehicle 10, the controller 31 identifies a record in which lighting information is stored in the theft-related information field of the vehicle information DB 321. Further, the controller 31 stores 1 in the number of times field of the specified record. Note that 0 is stored as the initial value in the number of times field. The controller 31 of the server 30 grants an incentive to the user in response to 1 being stored in the number of times field corresponding to the lighting information. The incentive may be, for example, a discount on the insurance of the vehicle 10. The discount rate of the insurance corresponding to the lighting information may be stored in the storage unit 32. In addition, the controller 31 may cause the storage unit 32 to store the calculated discount rate of the insurance. In addition, the controller 11 of the vehicle 10 may determine whether or not lighting is installed in the parking lot. Then, if the controller 11 of the vehicle 10 deems that a lighting is installed in the parking lot, it may notify the server 30 to that effect.

### Regarding (3)

The theft may be suppressed by attaching a lock to the steering wheel of the vehicle 10. Therefore, the controller 31 of the server 30 grants an incentive to the user based on the number of times the lock is attached to the steering wheel of the vehicle 10 or the time the lock is attached to the steering wheel of the vehicle 10. The lock referred to here is a lock that is detachable from the steering wheel and that is fixed to the steering wheel by attaching it to the steering wheel and locking it, thereby restricting the rotation of the steering wheel. This lock may be a metal rod-shaped lock that is secured to the steering wheel by a hook or clamp at two points in the diameter direction of the steering wheel. The controller 31 of the server 30 determines that the steering wheel is locked when, for example, with the IG-off, the steering grip sensor 18 detects grips at, for example, two points in the radial direction.

When the controller 31 of the server 30 determines that a lock is installed on the steering wheel, the controller 31 of the server 30 specifies a record in which the steering lock information is stored in the theft-related information field of the vehicle information DB 321. Further, the controller 31 adds 1 to the number of times stored in the number of times field of the specified record, so as to accumulate the number of times it is judged that the lock is attached to the steering wheel. The controller 31 stores the number of times after accumulation in the number of times field. As another example, the server 30 may accumulate the time that the lock is attached to the steering wheel. In addition, the controller 31 can also determine whether the lock is removed from the steering wheel based on the detection value of the steering grip sensor 18. Then, in the same manner as in (1), the controller 31 of the server 30 grants an incentive to the user based on the number of times accumulated or the time accumulated. The controller 31 may store, for example, the calculated discount rate of the insurance in the storage unit 32. In addition, the controller 11 of the vehicle 10 may determine whether or not a lock is attached to the steering wheel. Then, if the controller 11 of the vehicle 10 deems that a lock is attached to the steering wheel, it may notify the server 30 to that effect. Similarly, if the controller 11 of the vehicle 10 deems that the lock is removed from the steering wheel, it may notify the server 30 to that effect.

### Regarding (4)

The theft may be suppressed by parking the vehicle 10 in the parking lot with the shutter. The shutter may be a shutter that suppresses a third party from entering the parking lot, or may be a shutter that suppresses the vehicle 10 from exiting the parking lot. The controller 31 of the server 30 grants an incentive to the user based on the number of times the vehicle 10 is parked in the parking lot having the shutter or the time the vehicle 10 is parked in the parking lot having the shutter. The controller 31 determines whether or not the parking lot has a shutter by analyzing, for example, an image taken by the camera 17. Known technology may be used to make this determination. In addition, a machine learning model may be used to determine this. The controller 31 may analyze the image using a deep learning method such as, for example, YOLO, CNN, SDD, etc., and determine the presence of the shutter. In addition, the controller 31 determines that the vehicle 10 is parked when it changes from the IG-on state to the IG-off state. Note that the controller 31 may determine whether the vehicle 10 is parked in the parking lot with the shutter based on the image taken by the camera 17 in the predetermined period before and after parking. Further, as another example, an image of the vicinity of the position where the vehicle 10 is parked may be acquired from, for example, a server that provides external map information, and based on the image, the server 30 may determine whether the vehicle 10 is parked in the parking lot with the shutter. Further, as another example, the sonar or the radar attached to the vehicle 10 may be used to determine whether the controller 31 is parked in the parking lot where the vehicle 10 has a shutter. In that case, the controller 11 of the vehicle 10 transmits the detection value of the sonar or the radar attached to the vehicle 10 to the server 30. For example, when objects are detected in front of and behind the vehicle 10 with the IG-off, the controller 31 may determine that the vehicle 10 is parked in a parking lot that has a shutter.

When the controller 31 of the server 30 determines that the vehicle 10 is parked in a parking lot with a shutter, it identifies a record in which the shutter information is stored in the theft-related information field of the vehicle information DB 321. Further, the controller 31 adds 1 to the number of times stored in the number of times field of the specified record, so as to accumulate the number of times the vehicle 10 is determined to be parked in the parking lot having the shutter. The controller 31 stores the number of times after accumulation in the number of times field. As another example, the server 30 may accumulate the time that the vehicle 10 is parked in the parking lot having the shutter. Then, in the same manner as in (1), the controller 31 of the server 30 grants an incentive to the user based on the number of times accumulated or the time accumulated. The controller 31 may store, for example, the calculated discount rate of the insurance in the storage unit 32. In addition, the controller 11 of the vehicle 10 may determine whether the vehicle 10 is parked in the parking lot having the shutter. Then, if the controller 11 of the vehicle 10 deems that the vehicle 10 is parked in the parking lot having the shutter, it may notify the server 30 to that effect. In addition, the controller 31 may grant a predetermined incentive only when a shutter is provided in the parking lot of the user's home.

### Regarding (5)

If the user leaves the vehicle 10 without locking the door of the vehicle 10, the vehicle 10 may be stolen. Therefore, the controller 31 of the server 30 gives a larger incentive to the user the fewer the number of times the user leaves the vehicle 10 without locking the doors of the vehicle 10. When the controller 31 of the server 30 receives the unlocked information from the vehicle 10, the controller 31 identifies a record in which the unlocked information is stored in the theft-related information field of the vehicle information DB 321. In addition, the controller 31 accumulates the number of times the unlocked information is received by adding 1 to the number of times stored in the number of times field of the specified record. In addition, when the controller 31 of the server 30 receives the unlocked information from the vehicle 10, the controller 31 transmits a notification that the door of the vehicle 10 is not locked (hereinafter also referred to as the unlocked notification) to the user terminal 20. The destination for sending the unlocked notification is obtained from the information stored in the user terminal field of the vehicle information DB 321. Since the controller 31 transmits the unlocked notification to the user terminal 20 every time the unlocked information is received, the accumulated value of the number of times the unlocked information is received is equal to the accumulated value of the number of times the unlocked notification is sent.

Then, the controller 31 of the server 30 assigns an incentive to the user based on the number of times accumulated. The controller 31 of the server 30 may, for example, increase the discount rate of insurance as the number of times accumulated is small. The relationship between the number of times accumulated and the discount rate of the insurance may be stored in the storage unit 32. The controller 31 may cause the storage unit 32 to store the calculated discount rate of the insurance. As another example, the controller 31 may provide an incentive to the user when the number of times that unlocked information is received within a predetermined period is less than a threshold value. For example, the controller 31 may output information for providing an incentive to the user terminal 20 when the number of times that unlocked information is received within a predetermined period is less than a threshold value. The threshold may be different for each user, or may be a constant value regardless of the user. The predetermined period may be a contract period of insurance, or a predetermined period such as one week, one month, and one year.

### Regarding (6)

If the user leaves the vehicle 10 while the engine of the vehicle 10 is running, the vehicle 10 may be stolen. Therefore, the controller 31 of the server 30 increases the incentive to grant to the user as the number of times the user moves away from the vehicle 10 while the engine of the vehicle 10 is operated decreases. When the controller 31 of the server 30 receives the IG-on disembarkation information from the vehicle 10, the controller 31 specifies a record in which the IG-on disembarkation information is stored in the theft-related information field of the vehicle information DB 321. In addition, the controller 31 accumulates the number of times the IG-on disembarkation information is received by adding 1 to the number of times stored in the number of times field of the specified record.

Then, the controller 31 of the server 30 grants an incentive to the user based on the accumulated number of times in the same manner as in (5). In addition, as another example, the controller 31 may grant an incentive to the user when the number of times of the unlocked notification in the predetermined period is of less than the threshold value. For example, the controller 31 may output information for granting an incentive to the user terminal 20 when the number of times the IG-on disembarkation information is received in the predetermined period is less than the threshold. The threshold may be different for each user, or may be a constant value regardless of the user. The predetermined period may be a contract period of insurance, or a predetermined period such as one week, one month, and one year.

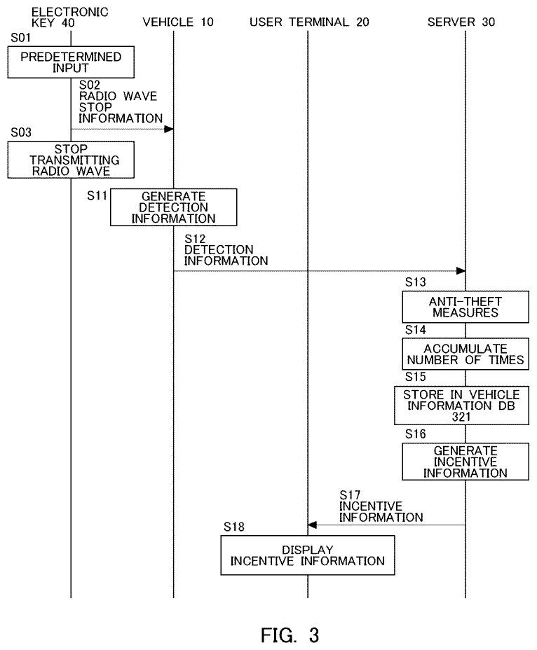

FIG. 3 is a sequence diagram illustrating an overall processing of a system 1 when incentivizing a user according to an embodiment. FIG. 3 shows an example in which radio wave transmission from the electronic key 40 is stopped. The controller 41 of the electronic key 40 receives a request to stop transmission of radio waves by detecting that the user has made a predetermined input to the push button group 42 (S01). The controller 41 of the electronic key 40 generates radio wave stop information and transmits it to the vehicle 10 (S02). Thereafter, the controller 41 of the electronic key 40 stops transmitting radio waves from the electronic key 40 (S03).

The controller 11 of the vehicle 10 that receives the radio wave stop information generates the detection information (S11). The detection information may include, in addition to the radio wave stop detection information corresponding to the radio wave stop information, a detection value of the position information sensor 14, an image taken by the camera 17, a detection value of the steering grip sensor 18, a detection value of the door sensor 19, information on the state of the unlocking lock of the door by the locking/unlocking unit 16, information on the state of the IG switch 15, unlocked information, and IG-on disembarkation information. Further, the detection information may include a vehicle ID and a user ID. However, not all of this information is required. For example, the controller 11 may generate and transmit only radio wave stop detection information. In this case, the controller 11 of the vehicle 10 may generate the radio wave stop detection information as a trigger when the radio wave stop information is received from the electronic key 40. When the detection information is generated, the controller 11 of the vehicle 10 transmits the detection information to the server 30 (S12).

The controller 31 of the server 30 that receives the detection information determines whether at least one of the above (1) to (6) has been performed (S13). In other words, it is determined whether or not an event related to the theft has occurred. The controller 31 determines, for example, that (1) described above has been performed when radio wave stop information is included in the detection information. Depending on the determination result of the processing in S13, the controller 31 identifies a corresponding record in the vehicle information DB 321, and adds 1 to the value stored in the number of times field of the identified record to accumulate the number of times (S14). For example, the controller 31 identifies a record in which radio wave stop detection information is stored in a theft-related information field of the vehicle information DB 321. This record is a record that matches the vehicle ID and user ID included in the theft-related information. Note that if the corresponding record does not exist, the controller 31 generates a new record. Further, the controller 31 of the server 30 accumulates the number of times the radio wave stop detection information is received by adding 1 to the number of times stored in the number of times field of the specified record.

Further, the controller 31 of the server 30 stores the calculated number of times in the number of times field of the vehicle information DB 321 (S15). In addition, the controller 31 generates information on incentives (hereinafter also referred to as incentive information) according to the information stored in the vehicle information DB 321 (S16). The controller 31 of the server 30 may, for example, generate incentive information so that the discount rate of the insurance increases as the number of times the radio wave stop detection information is received increases. When information relating to the number of times is stored in the number of times fields corresponding to a plurality of pieces of theft-related information, information relating to the incentive as a whole may be generated. The controller 31 may calculate a discount rate for the insurance premium corresponding to each piece of theft-related information, for example, based on the number of times each piece of theft-related information corresponds to, and use the average, maximum, or total value of these discount rates as the overall discount rate. In addition, the controller 31 may multiply the discount rate of the insurance premium of the vehicle 10 corresponding to each theft-related information by a predetermined coefficient, calculate the total value, and use the total value as the discount rate as a whole.

Further, the controller 31 of the server 30 transmits incentive information to the user terminal 20 at a predetermined time (S17). The controller 31 may transmit, together with the incentive information, a command to display an image corresponding to the incentive information on the display 24 of the user terminal 20. The controller 21 of the user terminal 20 that has received the incentive information causes the display 24 to display an image corresponding to the incentive information (S18). This image may be, for example, an image representing an approaching renewal of insurance of the vehicle 10 and a discount rate of insurance.

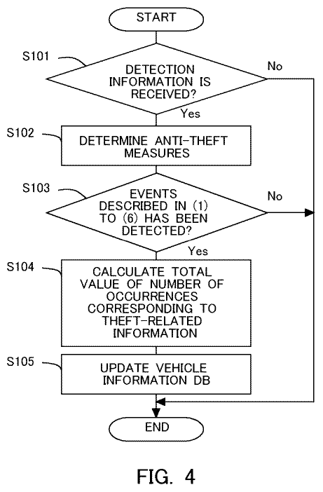

FIG. 4 is a flowchart illustrating processing of updating the vehicle information DB 321 in the server 30 according to an embodiment. The flowchart shown in FIG. 4 is executed for the vehicle 10 when the server 30 receives detection information from the vehicle 10 as a trigger.

In step S101, the controller 31 determines whether or not the detection information is received from the vehicle 10. If the controller 31 makes a positive determination in step S101, the processing proceeds to step S102, and if the negative determination is made, the routine is terminated. In step S102, the controller 31 analyzes in real time the detection value of the position information sensor 14, the image captured by the camera 17, the detection value of the steering grip sensor 18, the detection value of the door sensor 19, information regarding the door locking/unlocking status by the locking/unlocking unit 16, and information regarding the status of the IG switch 15, etc., to determine whether any of the above events (1) to (6) has occurred based on the received detection information. The controller 31 determines whether a stop of transmission of radio waves from the electronic key 40 is detected by, for example, determining whether radio wave stop detection information is included in the detection information. The controller 31 also determines, for example, by image analysis, whether or not the installation of lighting in the parking lot or parking in a parking lot with a shutter has been detected. In addition, the controller 31 determines, based on the detection value of the steering grip sensor 18, whether the attachment of the lock to the steering wheel of the vehicle 10 is detected. In addition, the controller 31 determines whether or not disembarking without locking the doors has been detected by, for example, determining whether or not unlocking information is included in the detection information. In addition, the controller 31 determines whether or not disembarking without stopping the engine has been detected by, for example, determining whether or not IG-on disembarking information is included in the detection information. Then, in step S103, the controller 31 determines whether or not the occurrence of any of the events described in (1) to (6) above has been detected based on the determination result of step S102. If the controller 31 makes a positive determination in step S103, the processing proceeds to step S104, and if a negative determination is made, the routine is terminated.

Next, in step S104, the controller 31 calculates the number of occurrences of the events determined in step S102. The number of occurrences so far is stored in the number of times field of the vehicle information DB 321. The controller 31 identifies a record in which the vehicle ID and the user ID match, and in which theft-related information corresponding to the event determined in step S102 is stored. Then, the controller 31 adds 1 to the value stored in the number of times field of the record, and calculates the total value of the number of occurrences corresponding to the theft-related information.

In step S105, the controller 31 updates the vehicle information DB 321 by storing the total value of the number of occurrences calculated in step S104 in the number of times field of the vehicle information DB 321.

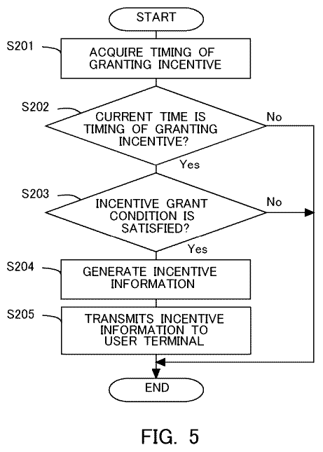

FIG. 5 is a flowchart showing a process of granting an incentive to a user in the server 30 according to the embodiment. The flowchart illustrated in FIG. 5 is performed at the server 30 every predetermined time and every vehicle 10. The routine shown in FIG. 5 may be executed when the process shown in FIG. 4 ends.

In step S201, the controller 31 acquires the timing of granting the incentive. The timing of granting the incentive may be, for example, daily, weekly, monthly, semi-annual, or yearly, or may be when the insurance for the vehicle 10 is renewed, or may be when the controller 31 completes processing of step S105 of the routine shown in FIG. 4. Note that the information on the timing of granting the incentive is stored in the storage unit 32.

In step S202, the controller 31 determines whether the current time is the timing of granting the incentive. If the controller 31 makes a positive determination in step S202, the processing proceeds to step S203, and if the negative determination is made, the routine ends. In addition, when the controller 31 grants an incentive in response to the completion of the process of step S105, the processes of steps S201 and S202 may be omitted.

In step S203, the controller 31 determines whether a condition for granting an incentive (hereinafter also referred to as an incentive grant condition) is satisfied. Whether or not the incentive granting condition is satisfied is determined by the controller 31 according to the number of times corresponding to, for example, the anti-theft information. The controller 31 may set, for example, at least one of the following as the incentive granting conditions in the vehicle information DB 321: the number of times corresponding to radio wave stop detection information is greater than or equal to a threshold, the number of times corresponding to lighting information is one or more, the number of times corresponding to steering lock information is greater than or equal to a threshold, the number of times corresponding to shutter information is greater than or equal to a threshold, the number of times corresponding to unlocked information is less than a threshold, and the number of times corresponding to IG-on disembarkation information is less than a threshold. The respective threshold values are stored in the storage unit 32. In addition, the processing of step S203 may be omitted.

In step S204, the controller 31 generates incentive information. For example, in the vehicle information DB 321, the controller 31 may generate incentive information so that the more times it corresponds to the radio wave stop detection information, the more times it corresponds to the steering lock information, the more times it corresponds to the shutter information, the fewer times it corresponds to the unlocked information, and the fewer times it corresponds to the IG-on disembarkation information, the greater the discount rate of the insurance of the vehicle 10. In addition, when the number of times corresponding to the lighting information is one or more times, the incentive information may be generated so that a predetermined discount rate is applied to the insurance of the vehicle 10.

In step S205, the controller 31 transmits the incentive information to the user terminal 20. At this time, the controller 31 also transmits a command to cause the display 24 of the user terminal 20 to display the image according to the incentive information. Note that the controller 31 may reset the number of times field of the vehicle information DB 321, for example, when the incentive information is transmitted to the user terminal 20, or may reset the number of times field at the timing of updating the insurance of the vehicle 10.

As explained above, according to the present embodiment, an incentive is granted to the user according to the number of occurrences of events related to anti-theft measures, so that anti-theft measures can be promoted. Thus, the number of thefts of the vehicle 10 can be reduced.

### Other Embodiments

The above-described embodiment and modification are merely examples, but the present disclosure can be implemented with appropriate modifications without departing from the spirit thereof. The processing and/or means (devices, units, parts, etc.) described in the present disclosure can be freely combined and implemented as long as no technical contradiction occurs. In addition, the processing described as being performed by a single device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner.

In the above-described embodiment, the server 30 transmits the incentive information to the user terminal 20, but the destination of the incentive information is not limited thereto. For example, if the incentive is a discount of the insurance premium of the vehicle 10, the controller 31 may transmit the incentive information to the terminal of the insurance company. In addition, if the incentive is an electronic money or a discount at the store, the controller 31 may transmit the incentive information to the store and the terminal of the payment company. In addition, the processing performed by the server 30 may be performed by the vehicle 10.

The present disclosure can also be realized by supplying to a computer a computer program in which the functions described in the above-described embodiment or modification are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. A system comprising:
an electronic key;
a vehicle having a function of a smart key corresponding to the electronic key;
a server having a controller and a storage;
a terminal of a user; wherein
the electronic key transmits, to the vehicle in response to an input that causes the transmission of the radio wave to be stopped, first information on the cessation of the transmission of the radio wave;
in response to receiving the first information from the electronic key, the vehicle transmits to the server second information regarding the electronic key stopping the transmission of the radio wave; and
the controller of the server is configured to:
calculate, in response to receiving the second information, a number of times the transmission of the radio wave is stopped in the electronic key, and storing the number of times in the storage;
generate third information for granting the incentive to the user so that the incentive increases as the number of times is increased; and
generate an instruction for causing the display of the generated image according to the third information on the display of the terminal of the user, and transmit the instruction to the terminal of the user; and
the terminal of the user, in response to receiving the command from the server, causes the image to be displayed on the display.

2. An information processing apparatus comprising a controller configured to execute:
receiving, from a vehicle, information corresponding to the vehicle theft prevention measures performed by a user; and
outputting information for granting incentives to the user in response to the information received from the vehicle.

3. The information processing apparatus according to claim 2, wherein
the vehicle theft prevention measures include at least one of:
stopping transmission of radio waves from an electronic key corresponding to a smart key provided in the vehicle;
installing lighting in a parking lot of the vehicle;
attaching a lock to a steering wheel of the vehicle; and
parking the vehicle in a parking lot having a shutter.

4. The information processing apparatus according to claim 2, wherein
the information corresponding to the vehicle theft prevention measures include information regarding locking of the vehicle when the user is not in the vehicle; and
the controller outputs the information for granting the incentive so that, in the predetermined period, the less number of times the vehicle is not locked when the user is not on board, the greater the incentive to grant to the user.

5. The information processing apparatus according to claim 2, wherein
the information corresponding to the vehicle theft prevention measures include information on disembarkation of the user when an engine of the vehicle is running, and
the controller outputs information for granting the incentive so that, in a predetermined period, the fewer times the user disembarks when the engine of the vehicle is running, the greater the incentive to grant to the user.

6. The information processing apparatus according to claim 2, wherein granting the incentive to the user includes discounting an insurance premium of the vehicle.
